(19) United States
(12) Patent Application Publication
(10) Pub. No.: US 2013/0154208 A1
(43) Pub. Date: Jun. 20, 2013

(54) SUSPENSION SYSTEM AND METHOD OF VARYING A STIFFNESS OF A SUSPENSION OF A VEHICLE

(71) Applicant: Prabhakar R. Marur, Bangalore (IN)

(72) Inventor: Prabhakar R. Marur, Bangalore (IN)

(73) Assignee: GM GLOBAL TECHNOLOGY OPERATIONS LLC, Detroit, MI (US)

(21) Appl. No.: 13/328,527

(22) Filed: Dec. 16, 2011

(51) Int. Cl. B60G 17/02; B60G 11/00

(52) U.S. Cl. 280/5.515; 280/124.164

(57) ABSTRACT

A suspension assembly for a vehicle is provided. The suspension system includes a suspension knuckle, a guide, and a spring. The guide is operatively attached to the suspension knuckle and extends longitudinally along a lateral axis. The spring extends between a first end and a second end. The first end of the spring is configured for operative attachment to the vehicle. The second end of the spring is movably attached to the guide and is configured for movement along the lateral axis to vary a stiffness of a suspension.

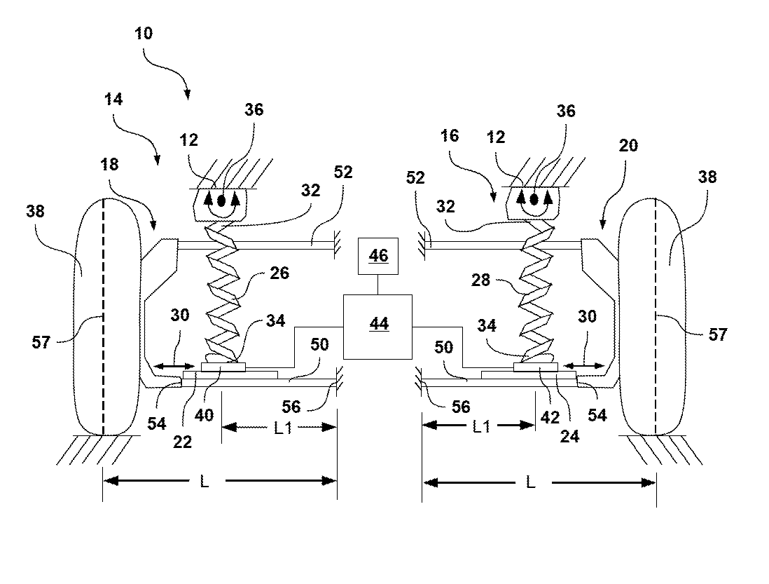

### TECHNICAL FIELD

The present disclosure relates to a system for varying a stiffness of a suspension of a vehicle.

### BACKGROUND

A typical vehicle includes a suspension system having a suspension knuckle and a spring fixedly attached to the vehicle and the suspension knuckle. Each suspension knuckle is attached to a wheel. The spring is configured to provide stiffness to the vehicle.

### SUMMARY

A suspension assembly for a vehicle is provided. The suspension system includes a suspension knuckle, a guide, and a spring. The guide is operatively attached to the suspension knuckle and extends longitudinally along a lateral axis. The spring extends between a first end and a second end. The first end of the spring is configured for operative attachment to the vehicle. The second end of the spring is movably attached to the guide and is configured for movement along the lateral axis to vary a stiffness of a suspension.

A suspension system for a vehicle includes a first suspension knuckle, a second suspension knuckle, a first guide, a second guide, a first spring, and a second spring. The first guide is operatively attached to the first suspension knuckle. The second guide is operatively attached to the second suspension knuckle. The first and second guides extend longitudinally along a respective lateral axis. Each spring extends between a first end and a second end. The first ends of the first and second springs are configured for operative attachment to the vehicle. The second end of the first spring is operatively attached to the first guide. The second end of the second spring is operatively attached to the second guide. The second ends of the first and second springs are configured for movement along the respective lateral axis to vary the stiffness of the suspension system.

A method of controlling a stiffness of a suspension system of a vehicle in response to an event while driving the vehicle includes operating the vehicle and sensing an event. An end of one of a first spring and a second spring is moved along a respective guide on a steering knuckle when the event equals a condition such that a length between the end of the one of a first spring and the second spring and an attachment point of the steering knuckle to the vehicle is varied.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

The FIGURE is a schematic diagrammatic view of a suspension system including a first suspension assembly, a second suspension assembly, a controller, and a sensor.

### DESCRIPTION OF THE PREFERRED EMBODIMENTS

Referring to the drawing, wherein like reference numbers refer to like components, a suspension system 10 for a vehicle 12 is shown. The suspension system 10 includes a first suspension assembly 14 and a second suspension assembly 16.

The first suspension assembly 14 includes a first suspension knuckle 18, a first guide 22, and a first spring 26. The second suspension assembly 16 includes a second suspension knuckle 20, a second guide 24, and a second spring 28.

For each suspension assembly 14, 16, the guide 22, 24 is operatively attached to the suspension knuckle 18, 20 and extends longitudinally along a lateral axis 30. The spring 26, 28 includes a stiffness K_{S} and extends between a first end 32 and a second end 34. The first end 32 of the spring 26, 28 is operatively attached to the vehicle 12 at an upper attachment point 36. The second end 34 of the spring 26, 28 is movably attached to the guide 22, 24 and is movable along the lateral axis 30 to vary a suspension stiffness K_{W} of the suspension system 10 at a wheel 38 of the vehicle 12, as will be explained in more detail below.

A first actuator 40 is operatively attached to the first guide 22 and a second actuator 42 is operatively attached to the second guide 24. The actuators 40, 42 are configured for moving the second end 34 of the respective spring 26, 28 along the lateral axis 30 of the respective guide 22, 24 in response to an event. The actuators 40, 42 may be a ball screw, a belt drive actuator, a segmented spindle, and the like. The actuators 40, 42 operate with very low friction and may be configured to move the second end 34 of the spring 26, 28 along the lateral axis 30 at a speed of 15 millimeters/second (mm/s) or more. It should be appreciated that other actuators 40, 42 may also be used.

A controller 44 is operatively connected to the each of the actuators 40, 42. Further, a sensor 46 is operatively connected to the controller 44. The sensor 46 is configured for sensing the event and sending a signal to the controller 44. The event may be a dynamic event, an operating state of the vehicle, and/or a performance value of the vehicle. By way of a non-limiting example, the event may be a yaw velocity of the vehicle 12, an angle of steering (steering angle sensor), a rate of steering angle change, an acceleration of the vehicle 12 at the wheel 38, and the like. The sensor 46 may also be a plurality of sensors 46. The controller 44 sends a signal to one or both of the actuators 40, 42 to move the second end 34 of the respective spring 26, 28 a desired distance along the respective guide 22, 24 in response to the event equaling a condition. The condition may be a value and/or a property of the event. By way of a non-limiting example, the condition may be a specified yaw velocity, a specified angle of steering, a specified rate of steering angle change, a specified acceleration of the vehicle 12 at the wheel 38, and the like. Therefore, the controller 44 can send a signal to move the actuators 40, 42 to vary the suspension stiffness K_{W} on demand to improve ride and handling of the vehicle 12, as required. This provides a high design bandwidth, with an ease of suspension tuning

The suspension knuckle 18, 20 includes a support member 48, a lower control arm 50, and an upper control arm 52. The support member 48 is configured for supporting the wheel 38 of the vehicle 12. The lower control arm 50 pivotally extends from the support member 48 at a support attachment 54 and pivotally attaches to the vehicle 12 at an attachment point 56. The guide 22, 24 is operatively supported by the lower control arm 50. The upper control arm 54 pivotally extends from the support member 48 in spaced relationship to the lower control arm 50.

A wheel length L is defined as a distance between the attachment point 56 and a center 57 of the wheel 38. A variable distance L1 is defined as a distance between the attachment point 56 and the second end 34 of the spring 26, 28. Movement of the second end 34 along the lateral axis 30 varies the length of the variable distance L1, while the wheel length L remains a fixed length. Therefore, varying the variable distance varies the suspension stiffness K_{W} at the wheel 38 based on the following relationship:

K_{W}=K_{S}(L₁/L)²

A suspension stiffness K_{W} can be varied as a ratio of the variable distance L1 to the wheel length L. Further, by moving the second end 34 of the spring 26, 28 linearly, along the lateral axis 30, actuation of the actuator 40, 42 requires only a limited amount of power. Therefore, the ability to vary the suspension stiffness K_{W} is achieved with a lightweight design.

As the second end 34 of the spring 26, 28 moves along the guide 22, 24, the first end 32 of the spring 26, 28 may pivot with respect to the vehicle 12 about the upper attachment point 36. It should be appreciated that the first end 32 may also be configured to move laterally with the second end 34, instead of pivoting about the attachment point 36.

While the best modes for carrying out the disclosure have been described in detail, those familiar with the art to which this disclosure relates will recognize various alternative designs and embodiments for practicing the disclosure within the scope of the appended claims.

1. A suspension assembly for a vehicle, the suspension system comprising:
a suspension knuckle;
a guide operatively attached to the suspension knuckle and extending longitudinally along a lateral axis; and
a spring extending between a first end and a second end;
wherein the first end of the spring is configured for operative attachment to the vehicle;
wherein the second end of the spring is movably attached to the guide and configured for movement along the lateral axis to vary a stiffness of a suspension.

2. A suspension assembly, as set forth in claim 1, further comprising an actuator configured for moving the second end of the spring along the guide.

3. A suspension assembly, as set forth in claim 2, wherein the actuator moves the second end of the spring along the lateral axis of the guide in response to an event.

4. A suspension assembly, as set forth in claim 2, wherein the actuator is one of a ball screw, a belt drive actuator, and a segmented spindle.

5. A suspension assembly, as set forth in claim 1, further comprising a controller operatively connected to the actuator;
wherein the controller is configured for sending a signal to the actuator to move the second end of the spring along the guide in response to an event.

6. A suspension assembly, as set forth in claim 5, further comprising a sensor operatively connected to the controller and configured for sensing the event.

7. A suspension assembly, as set forth in claim 1, wherein the suspension knuckle includes:
a support member configured for supporting a wheel; and
a lower control arm pivotally extending from the support member and configured for attachment to the vehicle at an attachment point;
wherein the guide is operatively supported by the lower control arm.

8. A suspension assembly, as set forth in claim 7, wherein the suspension knuckle further includes an upper control arm pivotally extending from the support member in spaced relationship to the lower control arm.

9. A suspension system for a vehicle comprising:
a first suspension knuckle;
a second suspension knuckle;
a first guide operatively attached to the first suspension knuckle;
a second guide operatively attached to the second suspension knuckle;
wherein the first and second guides extend longitudinally along a respective lateral axis;
a first spring; and
a second spring;
wherein each spring extends between a first end and a second end;
wherein the first ends of the first and second springs are configured for operative attachment to the vehicle;
wherein the second end of the first spring is operatively attached to the first guide;
wherein the second end of the second spring is operatively attached to the second guide; and
wherein the second ends of the first and second springs are configured for movement along the respective lateral axis to vary the stiffness of the suspension system.

10. A suspension system, as set forth in claim 9, further comprising a first actuator and a second actuator;
wherein the first and second actuator is configured for moving the second end of the respective first and second spring along the guide.

11. A suspension system, as set forth in claim 10, wherein the first and second actuator moves the second end of the respective first and second spring along the lateral axis of the guide in response to an event.

12. A suspension system, as set forth in claim 10, wherein the first and second actuator is one of a ball screw, a belt drive actuator, and a segmented spindle.

13. A suspension system, as set forth in claim 9, further comprising a controller operatively connected to the first and second actuator;
wherein the controller is configured for sending a signal to at least one of the first and second actuator to move the second end of the respective first and second spring along the respective first and second guide in response to an event.

14. A suspension system, as set forth in claim 9, wherein the first and second suspension knuckles each include:
a support member configured for supporting a wheel; and
a lower control arm pivotally extending from the support member and configured for attachment to the vehicle at an attachment point;
wherein the lower control arm operatively supports the respective first and second guide.

15. A suspension system, as set forth in claim 14, wherein the first and second suspension knuckles further include an upper control arm pivotally extending from the support member in spaced relationship to the lower control arm.

16. A method of controlling a stiffness of a suspension system of a vehicle in response to an event while driving the vehicle, the method comprising:
operating the vehicle;
sensing an event;
moving an end of one of a first spring and a second spring along a respective guide on a steering knuckle when the event equals a condition to vary a length between the end of the one of a first spring and the second spring and an attachment point of the steering knuckle to the vehicle.

17. A method, as set forth in claim 16, wherein moving is further defined as energizing an actuator to move the second end of the one of the first and second springs along a lateral axis to vary the variable length when the event equals a condition.
